(19) United States
(12) Patent Application Publication
(10) Pub. No.: US 2019/0308299 A1
(43) Pub. Date: Oct. 10, 2019

(54) ARRANGEMENT AND PROCESS FOR TREATING A SURFACE

(71) Applicant: L'Air Liquide, Société Anonyme pour l'Etude et l'Exploitation des Procédés Georges Claude, Paris (FR)

(72) Inventor: Cerkez KAYA, Krefeld (DE)

(21) Appl. No.: 16/467,578

(22) PCT Filed: Dec. 6, 2017
(86) PCT No.: PCT/EP2017/081736

§ 371 Date: Jun. 7, 2019

(30) Foreign Application Priority Data
Dec. 8, 2016 (DE) 10 2016 123 814.7

(51) Int. Cl. B24C 5/04; B24C 1/00; B05B 7/14; B05B 7/04

(52) U.S. Cl. CPC B24C 5/04; B05B 7/04; B05B 7/1481; B24C 1/003

(57) ABSTRACT

An apparatus and method for treating a surface with a jet comprising a multiplicity of particles, the apparatus including at least one nozzle unit, which is designed for providing a stream of propellant gas mixed with a multiplicity of particles, and an enclosure of the nozzle unit, the enclosure being arranged at such a distance from the nozzle unit that a gap is formed between the nozzle unit and the enclosure.

### CROSS REFERENCE TO RELATED APPLICATIONS

This application is a 371 of International PCT Application No. PCT/EP2017/081736, filed Dec. 6, 2017, which claims priority to German Patent Application No. DE 10 2016 123 814.7, filed Dec. 8, 2016, the entire contents of which are incorporated herein by reference.

### BACKGROUND

The invention relates to an arrangement and a process for treating a surface, in particular with a jet comprising a multiplicity of particles.

In many situations, a surface has to undergo mechanical cleaning. It may for instance be necessary in the production of wires for example to clean the finished product to ensure product quality. In solutions known for doing this, a wide variety of chemical and/or mechanical cleaning processes are used. The following come into consideration for example: grinding, brushing, ultrasonic exposure or superheated steam treatment. In particular, it is also known to treat surfaces with a jet of carbon dioxide particles.

These processes are also used in the production of plastic products for removing flash from a surface of the plastic products produced.

In known processes in which solid particles are used, for example of carbon dioxide, there are in particular frequent occasions when, because of the low temperatures, outer walls of the nozzles cool down to such an extent that condensed water can form on them and may freeze. This may be detrimental to the use of such a nozzle. It may also lead to poor energy efficiency.

### SUMMARY

On this basis, the object of the present invention here is to overcome at least partially the technical problems described in connection with the prior art. In particular, an energy-efficient arrangement for treating a surface is intended to be presented. A corresponding process is also intended to be presented.

These objects are achieved by an arrangement and a process for treating a surface according to the features of the independent patent claims. Further advantageous refinements of the arrangement and of the process are provided in the respectively independently formulated patent claims. The features set out individually in the patent claims can be combined with one another in any desired, technologically meaningful way and can be supplemented by explanatory substantive matter from the description, demonstrating further variants for the embodiment of the invention.

According to the invention, an arrangement for treating a surface with a jet comprising a multiplicity of particles is presented. The arrangement comprises at least:
at least one nozzle unit, which is designed for providing a stream of propellant gas mixed with a multiplicity of particles, and
an enclosure of the nozzle unit, the enclosure being arranged at such a distance from the nozzle unit that a gap is formed between the nozzle unit and the enclosure.

The arrangement described is used for example in particular in the production of wire and plastic products, but can also be used in other applications, in particular in principle in the case of carbon dioxide jets. With the arrangement described, for example, cleaning the surface of a produced wire or a produced plastic product can be carried out. Flash or burr may also be removed from the surface of a produced wire or plastic product. Removing flash or burr means that excess material is removed from the surface. The excess material may be formed in particular as flash or burr at those places at which parts of a casting mould have been put together and/or at which an inlet for casting material into the casting mould is provided.

The particles are preferably formed from a substance that is liquid or gaseous a room temperature. In particular whenever the substance is gaseous at room temperature, the treatment of a surface can be carried out without residues of the substance remaining on the surface. The substance is preferably carbon dioxide. The particles may in particular take the form of snow, such as for example carbon dioxide snow.

The arrangement, and in particular the component parts of the arrangement that can come into contact with the substance and/or with the particles, is/are preferably formed with a material that can withstand low temperatures to be expected when that happens. In the case of solid carbon dioxide, the temperature may for example lie at approximately −80° C. Steel in particular, preferably high-grade steel, is preferred as the material for the arrangement. The enclosure, which preferably cannot come into contact with the substance and/or with the particles, may conversely be formed from another material. In particular, it is preferred that the enclosure is formed with a material that has a lower thermal conductivity than steel.

In order to generate the jet comprising the multiplicity of particles, first the stream of propellant gas is provided in the nozzle unit. This may be performed for example by a compressor. The stream of propellant gas is preferably a stream of compressed air. However, a gas other than air, such as for example nitrogen or carbon dioxide, may also be used.

The stream of propellant gas may for example be mixed with the particles in that the particles are formed from a solid starting material and are introduced into the stream of propellant gas or in that a liquid starting material is injected into the nozzle unit, whereby a snow can form in particular from the liquid starting material.

The enclosure preferably surrounds the regions of the nozzle unit that are at a low temperature during operation. A low temperature should be understood in this connection as meaning a temperature below a customary room temperature, in particular 20° C., and in particular of below 0° C. It is also preferred that an entire outer wall of the nozzle unit is surrounded by the enclosure.

The nozzle unit can be thermally insulated from the surroundings by the enclosure. The thermal insulation may be achieved in particular by a gas, such as for example air or nitrogen, flowing in the gap. It is therefore also preferred that the nozzle unit and the enclosure are formed with a material with a low thermal conductivity. This may be for example plastic, in particular expanded plastic or a plastic-metal composite material. The thermal insulation may be all the more pronounced the lower a gas pressure in the gap between the nozzle unit and the enclosure is. It is therefore also preferred that there is in the gap a negative pressure below 300 hPa [hectopascals] or even a vacuum with a pressure below 300 hPa.

A gas located in the gap can develop the described thermal insulating effect equally if it flows through the gap as a gas stream. Apart from the thermal insulating effect, such a gas stream can suppress the formation of condensed water particularly well, since condensed water possibly forming is carried away by the gas stream. The gas stream preferably has a low moisture content before entering the gap, so that the gas stream reduces the occurrence of condensed water and is good at absorbing again condensed water nevertheless occurring. If the cold surface of the nozzle unit is flowed over by a dry gas stream, the formation of condensed water can be prevented or at least reduced by a low moisture content in the surroundings of the surface. Condensed water nevertheless occurring can be absorbed and removed by the gas stream directly after it occurs.

In a preferred embodiment of the arrangement, the enclosure is formed at least partially with (or from) a plastic.

On account of the thermal properties of plastic, this material is particularly preferred for the enclosure. This applies in particular to the thermal conductivity and the heat capacity of plastic. Plastic can make a particularly good thermal insulation of the surroundings of the nozzle unit possible.

In a further preferred embodiment of the arrangement, the gap has the same extent at every point of the nozzle unit.

In this embodiment, the gas stream can flow uniformly through the gap. This can prevent that the formation of condensed water is not sufficiently suppressed at individual points of the gap as a result of a flow rate that is too low. An extent of the gap that is too small at some points may also lead to inadequate thermal insulation of the surroundings. In turn, a gap that is in this respect too wide at certain points may increase the size of the arrangement unnecessarily.

In a further preferred embodiment of the arrangement, the nozzle unit comprises at least a mixing chamber and an inner nozzle.

The mixing chamber is preferably designed to mix the stream of propellant gas with the multiplicity of particles. This should be understood as meaning that the mixing chamber is configured and connected to the particle generator in such a way that, after passing through the mixing chamber, the stream of propellant gas comprises the multiplicity of particles. The stream of propellant gas mixed with the multiplicity of particles in this way can be let out of the nozzle unit through the inner nozzle.

In a further preferred embodiment of the arrangement, an inlet into the mixing chamber has an inlet cross-sectional area that differs from a nozzle cross-sectional area of the inner nozzle.

It is preferred that the inner nozzle adjoins the mixing chamber and is connected to it in terms of flow. It is also preferred that the inner nozzle has an outlet for the stream of propellant gas, the nozzle cross-sectional area of the inner nozzle as it progresses from the mixing chamber at first being reduced in size to a minimum nozzle cross-sectional area, then being increased in size again. It is also preferred that an area quotient between the minimum nozzle cross-sectional area and the inlet cross-sectional area lies in the range from 15 to 300, preferably in the range from 25 to 225.

It has surprisingly been found by trials that the ratio between the inlet cross-sectional area and the minimum nozzle cross-sectional area, in particular the area quotient, has a particularly great influence on the thorough mixing of the stream of propellant gas with the particles. It has been found that the influence of the area quotient is in particular considerably greater than the influence of individual customarily varied parameters.

In a further preferred embodiment, the arrangement also comprises a particle generator.

The particle generator is preferably designed to generate the multiplicity of particles and introduce them into the mixing chamber in a solid state. The particle generator preferably has at least one screen plate, it being possible for the multiplicity of particles to be formed in a solid state by pressing a solid starting material through the screen plate. The nozzle unit also preferably has a propellant gas line with a propellant gas nozzle for introducing the propellant gas into the mixing chamber and an outlet from the mixing chamber for the stream of propellant gas.

The particle generator is preferably configured in such a way that the solid starting material can be pressed against the screen plate by way of a conveying screw or by way of a pneumatic or mechanical press. The generation of particles by means of the particle generator allows particularly large particles to be provided and mixed with the stream of propellant gas. The particles can thus be in particular larger than those that can be formed for example by atomization (expansion) of liquid carbon dioxide, Larger particles can have greater kinetic energy, and can therefore have a greater effect on the treatment of the surface. For example, with large particles, heavy soiling of a surface can be removed. The fact that the screen plate makes it possible to generate large particles of a uniform size means that a great and also uniform effect can be achieved with the arrangement described.

According to a further aspect of the invention, a process for treating a surface with a jet comprising a multiplicity of particles is presented, an arrangement as described being used.

The special advantages and design features of the arrangement that are described further above can also be applied and transferred to the process described, and vice versa.

In a preferred embodiment of the process, the treating of the surface comprises at least one of the following steps:
cleaning the surface, and
removing flash or burr from the surface.

The specified steps may be carried out alternatively or cumulatively, that is to say that a surface may just be cleaned, just have flash or burr removed or both be cleaned and have flash or burr removed.

### BRIEF DESCRIPTION OF THE DRAWINGS

The invention and the technical environment are explained in more detail below on the basis of the FIGURE. The FIGURE shows a particularly preferred exemplary embodiment, to which however the invention is not restricted. In particular, it should be pointed out that the FIGURE, and in particular the relative sizes represented, are only schematic. In the FIGURE:

FIG. 1 schematically shows a lateral sectional representation of an arrangement for treating a surface.

### DESCRIPTION OF PREFERRED EMBODIMENTS

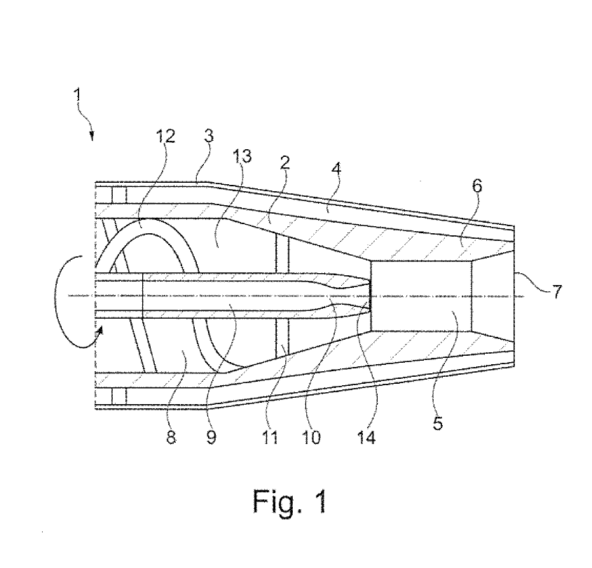

FIG. 1 shows a lateral sectional representation of an arrangement 1 for treating a surface with a jet comprising a multiplicity of particles. The arrangement 1 comprises a nozzle unit 2, which is designed to provide a stream of propellant gas mixed with a multiplicity of particles. The nozzle unit 2 is surrounded by an enclosure 3. The enclosure 3 is arranged at such a distance from the nozzle unit 2 that a gap 4 is formed between the nozzle unit 2 and the enclosure 3.

The nozzle unit 2 comprises a mixing chamber 5 for mixing a stream of propellant gas with the multiplicity of particles. The nozzle unit 2 also comprises an inner nozzle 6 with an outlet 7, The nozzle unit 2 also comprises a particle generator 8, which is designed to generate the multiplicity of particles and introduce them into the mixing chamber 5 in a solid state. The particle generator 8 has a screen plate 11 and a conveying screw 12. By pressing a solid starting material 13 through the screen plate 11 by means of the conveying screw 12, the multiplicity of particles can be formed in a solid state and introduced into the mixing chamber 5.

Furthermore, the nozzle unit 2 has a propellant gas line 9 with a propellant gas nozzle 10 for introducing the propellant gas into the mixing chamber 5 by way of an inlet 14.

With the arrangement presented and the process presented for treating a surface, a particularly energy-efficient treatment of the surface can be achieved, in particular by thermal insulation and by suppressing the formation of condensed water. This applies in particular to cleaning and removing flash or burr. The arrangement and the process may be used in particular in the production of wire or plastic products.

### LIST OF DESIGNATIONS

1 arrangement
2 nozzle unit
3 enclosure
4 gap
5 mixing chamber
6 inner nozzle
7 outlet
8 particle generator
9 propellant gas line
10 propellant gas nozzle
11 screen plate
12 conveying screw
13 solid starting material
14 inlet

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-9. (canceled)

10. An apparatus for treating a surface with a jet comprising a multiplicity of particles, the apparatus comprising:
at least one nozzle unit, configured to provide a stream of propellant gas mixed with a multiplicity of particles, and
an enclosure of the nozzle unit, the enclosure arranged at such a distance from the nozzle unit that a gap is formed between the nozzle unit and the enclosure.

11. The apparatus of claim 10, wherein the enclosure is formed at least partially from a plastic.

12. The apparatus of claim 10, wherein the gap has the same extent at every point of the nozzle unit.

13. The apparatus of claim 10, wherein the nozzle unit comprises at least a mixing chamber and an inner nozzle.

14. The apparatus of claim 13, further comprising an inlet into the mixing chamber having an inlet cross-sectional area that differs from a nozzle cross-sectional area of the inner nozzle.

15. The apparatus of claim 10, further comprising a particle generator.

16. A process for treating a surface with a jet comprising a multiplicity of particles, utilizing the apparatus of claim 10.

17. The process of claim 16, wherein a stream of gas between the nozzle unit and the enclosure is generated.

18. The process according to claim 17, wherein the treating of the surface comprises at least one of the following steps:
cleaning the surface, and
removing flash or burr from the surface.
